(19) United States
(12) Patent Application Publication
(10) Pub. No.: US 2024/0308132 A1
(43) Pub. Date: Sep. 19, 2024

(54) ADDITIVE MANUFACTURING METHOD, POLYMER POWDER COMPOSITION COMPRISING A DETECTION ADDITIVE, AND OBJECT OBTAINED BY SAID METHOD

(71) Applicant: FABULOUS, VAULX EN VELIN (FR)

(72) Inventors: Olivier COULET, Chassieu (FR); Rita FETEIRA ESCUDEIRO, Lyon (FR); Arnault COULET, Paris (FR)

(21) Appl. No.: 18/571,219

(22) PCT Filed: Jun. 14, 2022
(86) PCT No.: PCT/IB2022/055495

§ 371 Date: Dec. 16, 2023

(30) Foreign Application Priority Data
Jun. 17, 2021 (FR) 2106442

(51) Int. Cl. B29C 64/153; B29C 64/255; B29C 64/357; B29K 77/00; B29K 105/00; B29K 105/16; B29K 105/26; B33Y 10/00; B33Y 30/00; B33Y 70/00; C08K 3/22

(52) U.S. Cl. CPC B29C 64/153; B29C 64/255; B29C 64/357; B33Y 10/00; B33Y 30/00; B33Y 70/00; C08K 3/22; B29K 2077/00; B29K 2105/0032; B29K 2105/0094; B29K 2105/16; B29K 2105/251; B29K 2105/26; B29K 2995/0094; C08K 2003/2227; C08K 2003/2289; C08K 2201/01

(57) ABSTRACT

The invention relates to a method for manufacturing a three-dimensional object, comprising locally raising the temperature of a powder using electromagnetic radiation in a heated chamber, causing the localised melting/coalescing of a layer of a predetermined thickness in order to form, after cooling, a solid polyamide layer, the method being characterised in that the powder comprises, relative to the total weight of the composition: —between 60% and 99% by weight of polyamide; —between 1% and 40% by weight of an optical and/or magnetic detection additive selected from the group formed by: pigments comprising a spinel structure containing a cation of a transition metal, the oxides of a transition metal, the sulphides of a transition metal; —between 0% and 5% by weight of a flow agent and in that the powder has: —a particle size distribution D₅₀ of between 35 μm and 55 μm; and —a particle size distribution D₁₀ of more than 15 μm; and—a particle size distribution D₉₀ of less than 100 μm.

### CROSS-REFERENCE TO RELATED APPLICATIONS

The present application is a National Stage Application of PCT International Application No. PCT/IB2022/055495 (filed on Jun. 14, 2022), under 35 U.S.C. § 371, which claims priority to French Patent Application No. 2106442 (filed on Jun. 17, 2021), which are each hereby incorporated by reference in their complete respective entireties.

### TECHNICAL FIELD

The present invention relates to the manufacture of parts made of polymer materials and relates to a process for agglomeration, layer by layer, in particular by melting or sintering, of a polymer powder comprising an optical and/or magnetic detection additive. The present invention also relates to such a polymer powder supplied for this process and consumed during the process. The present invention finally aims at an object obtained by the process which has particularly advantageous properties in the field of safety of food production chains.

### BACKGROUND

Among the great diversity of additive manufacturing technologies for parts made of polymer materials that are nowadays available, the present application falls within the framework of technologies involving an agglomeration of powder, layer by layer, with a view to obtaining a three-dimensional object. Thus, in the context of this document, we designate these methods only by the terms “additive manufacturing” or “3D printing”. We will refer to a “3D object” as an object obtained by such a 3D printing method.

In this context, the agglomeration of powders by fusion, coalescence, and/or “sintering” is caused by radiation allowing to melt the material to be agglomerated. For example, Selective Laser Sintering (SLS) consists of locally densifying a material presented in powder form, by melting it under the action of a laser. Any other source of electromagnetic radiation allowing to melt the powder can also be used, for example infrared, visible or UV radiation. Other notable methods of additive manufacturing by fusion of a powder bed include Laser Sintering, Multi Jet Fusion, Infrared Radiation Sintering and High Speed Sintering.

The use of 3D objects made of thermoplastics is advantageous in industrial production chains, in particular because such objects can be produced in small series for specific uses or because they present specific structural characteristics. However, 3D objects made of thermoplastics are difficult to detect by the means of detecting foreign bodies which are usually implemented as part of online quality control, particularly in the food industry. So if a 3D thermoplastic object breaks, fragments can end up in the product and represent a food safety risk.

The additive manufacturing processes known from the prior art and the powders they use do not make it possible to produce 3D objects having both satisfactory mechanical properties for use in industry and strong detectability by means of detection of foreign bodies, for example by magnetic detection or by detection of an unusual color.

### SUMMARY

The present invention aims to remedy all or part of these drawbacks.

To this end, according to a first aspect, the present invention relates to a method of manufacturing a three-dimensional object, comprising a local increase in the temperature of a polyamide-based powder by electromagnetic radiation in a heated enclosure, causing localized melting of a layer of a predetermined thickness to form, after cooling, a solid layer of polyamide, said process being characterized in that said powder comprises, with respect to the total weight of the composition:
between 60% and 99% by weight of polyamide;
between 1% and 40% by weight of an optical and/or magnetic detection additive selected from the group formed by: pigments comprising a spinel structure which contains a cation of a transition metal, sulphides of a transition metal;
between 0% and 5%, and preferably between 0.1% and 4.5%, by weight of a flow agent;
and in that the powder presents:
a particle size distribution D₅₀ comprised between 35 μm and 55 μm; and
a particle size distribution D₁₀ greater than 15 μm and
a particle size distribution D₉₀ less than 100 μm.

In specific embodiments, the powder has:
a particle size distribution D₅₀ comprised between 35 μm and 55 μm,
a particle size distribution D₁₀ comprised between 15 μm and 25 μm and
a particle size distribution D₉₀ comprised between 80 μm and 100 μm.

In specific embodiments, the particle size distribution D₁₀ is greater than 10 μm, preferably greater than 15 μm, preferably greater than 17 μm, preferably greater than 20 μm.

In specific embodiments, the particle size distribution D₅₀ is less than 110 μm, preferably less than 100 μm, preferably less than 95 μm, preferably less than 93 μm, preferably less than 90 μm. In specific embodiments, the particle size distribution D₅₀ is less than 80 μm.

In specific embodiments, a mass fraction of between 30% and 70% of said powder is fresh polyamide powder, and a mass fraction of between 70% and 30% of said powder is polyamide powder recovered in said heated enclosure after a previous run of manufacture, and said fresh polyamide powder has an internal viscosity number measured according to ISO 307:2019 comprised between 0.9 deciliters per gram and 1.4 deciliters per gram, at 25° C.

In specific embodiments, the electromagnetic radiation causing localized melting of a layer is laser radiation with an energy density greater than or equal to 25 mJ/mm².

The method used in this case is preferably the selective laser sintering method, more often called SLS (abbreviated from “Selective Laser Sintering”).

According to a second aspect, the invention relates to a powder composition for an additive manufacturing process characterized in that it comprises, with respect to the total weight of the composition:
between 60% and 99% by weight of polyamide;
between 1% and 40% by weight of a detection additive, preferably an optical detection additive and/or a magnetic detection additive, selected from the group formed by: pigments comprising a spinel structure which contains a cation a transition metal, the oxides of a transition metal, the sulphides of a transition metal;
between 0% and 5%, and preferably between 0.1% and 4.5%, by weight of a flow agent;
and in that the powder presents:
a particle size distribution D₅₀ comprised between 35 μm and 55 μm; and
a particle size distribution D₁₀ greater than 15 μm, and
a particle size distribution D₉₀ less than 100 μm.

In specific embodiments, the powder composition of the invention is obtained by dry mixing a natural polyamide powder with a polyamide powder comprising a detection additive.

In specific embodiments, the powder composition according to the invention comprises:
between 0.05% and 5% by weight of an optical detection additive chosen from pigments comprising a spinel structure which contains a cation of a transition metal and
between 1% and 35% by weight of a magnetic detection additive chosen from transition metal oxides.

Alternatively, the optical or magnetic detection additive is chosen from the sulphides of a transition metal.

In specific embodiments, the powder composition which is the subject of the invention has an internal viscosity number measured according to ISO 307:2019 comprised between 0.9 deciliters per gram and 1.4 deciliters per gram.

In specific embodiments, the powder composition which is the subject of the invention has a value ΔT=(Tₘ−T_{c})ₒₙₛₑₜ comprised between 30° C. and 50° C.

In specific embodiments, the powder composition which is the subject of the invention comprises an optical detection additive and said optical detection additive comprises cobalt blue.

According to a third aspect, the invention relates to a three-dimensional object obtained by additive manufacturing from a composition which is the subject of the invention.

In specific embodiments, the three-dimensional object is colored blue in the mass by an optical detection additive. Preferably, the optical detection additive allows optical detection in a wavelength range comprised between 0.5 μm and 12 μm.

In specific embodiments, the three-dimensional object has an elastic modulus greater than or equal to 1700 MPa, a tensile strength greater than or equal to 30 MPa, an elongation at break greater than or equal to 20% in a first orientation and greater than or equal to 35% in a second orientation perpendicular to the first.

### DRAWINGS

Other advantages, aims and particular characteristics of the invention will emerge from the following non-limiting description of at least one particular embodiment of the additive manufacturing process, of the powder composition for said process and of a three-dimensional object obtained by said process, all of which are objects of the present invention, with reference to the appended drawings, in which:

FIG. 1 represents particle size distribution density curves as a function of particle size for two powder compositions according to the invention and of a natural polyamide 11 powder,

FIG. 2 represents cumulative distribution curves as a function of circularity for two powder compositions according to the invention and for a natural polyamide 11 powder,

FIG. 3 represents a picture taken with a scanning electronic microscope of a powder composition according to the invention,

FIG. 4 represents a picture obtained by X-ray tomography of a section of a 3D object obtained from the additive manufacturing process using the powder composition illustrated in FIG. 3,

FIG. 5 schematically represents a section of a 3D object obtained by sintering of the powder composition illustrated in FIG. 3,

FIG. 6 represents a picture taken with a scanning electron microscope of a powder composition for additive manufacturing,

FIG. 7 represents a picture obtained by X-ray tomography of a section of a 3D object obtained from the sintering process using the powder composition illustrated in FIG. 6,

FIG. 8 schematically represents a section of a 3D object obtained by sintering of the powder composition illustrated in FIG. 6,

FIG. 9 represents a differential scanning calorimetry (DSC) of a particular powder composition according to the invention,

FIG. 10 represents a graph of the force in MPa as a function of the elongation in an xy orientation, expressed in %, obtained from an elongation test on a 3D object obtained by sintering of a composition of powder A, according to a particular embodiment of the invention,

FIG. 11 represents a graph of the force in MPa as a function of the elongation in an xz orientation, expressed in %, obtained at the end of an elongation test on a 3D object obtained by sintering a powder composition A, according to a particular embodiment of the invention, and

FIG. 12 represents a graph which shows the volume particle size distribution as a function of the particle size of a powder composition according to the invention.

### DESCRIPTION

The present description is given on a non-limiting basis, each characteristic of an embodiment being able to be combined with any other characteristic of any other embodiment in an advantageous manner.

The numerical values of the internal viscosity number of polyamide given in the present document refer to the ISO 307:2019 standard and a temperature of 25° C.

The powder composition for additive manufacturing process by sintering according to the invention comprises, with respect to the total weight of the composition:
between 60% and 99% by weight of polyamide,
between 1% and 40% by weight of a detection additive, which may be an optical detection additive and/or a magnetic detection additive, and which is preferably selected from the group formed by: pigments comprising a spinel structure which contains a cation of a transition metal, the oxides of a transition metal, the sulphides of a transition metal;
between 0% and 5% and preferably between 0.1% and 4.5% by weight of a flow agent, and wherein the powder presents:
a particle size distribution D₅₀ comprised between 35 μm and 55 μm; and
a particle size distribution D₁₀ greater than 15 μm and
a particle size distribution D₉₀ less than 100 μm.

The powder is called “polyamide-based” because it mainly comprises polyamide.

The characteristics of the powder composition for additive manufacturing process by sintering, hereinafter “sintering powder”, and its components are detailed below.

The shape of the grains of the sintering powder is preferably spherical.

According to the invention, said detection additive can be selected so as to allow magnetic detection or optical detection, or two additives can be used, namely a first additive allowing magnetic detection and a second additive allowing optical detection, or else an additive allowing both optical detection and magnetic detection can be used.

### Choice of Polyamide or Polyamide Mixture

The polyamide can be chosen from any available polyamide, or mixture of polyamides, making it possible to obtain the particle size characteristics of the composition of the invention.

Preferably the polyamide is chosen from polyamides comprising one of the following monomers: PA6, PA10, PA11, PA12 and their mixtures.

In particular, PA11 can be used due to its advantageous characteristics and its biosourced origin. A “biosourced” product is a product that is either entirely or partially manufactured from materials of biological origin.

### Characteristics of the Sintering Powder and Working Temperature (T₂)

Preferably, the sintering powder has a working temperature window of between 160° C. and 210° C. The working temperature window is the temperature interval delimited by the initial temperature extrapolated from the melting peak (T_{ei.m} or T_{m,onset} expressed in ° C.) and the final temperature extrapolated from the crystallization peak (T_{ef,c} or T_{c,onset} expressed in ° C.).

The difference between these two temperatures is called ΔT, expressed as follows: ΔT=T_{ei.m}−T_{ef.c} or ΔT=(Tₘ−T_{c})ₒₙₛₑₜ.

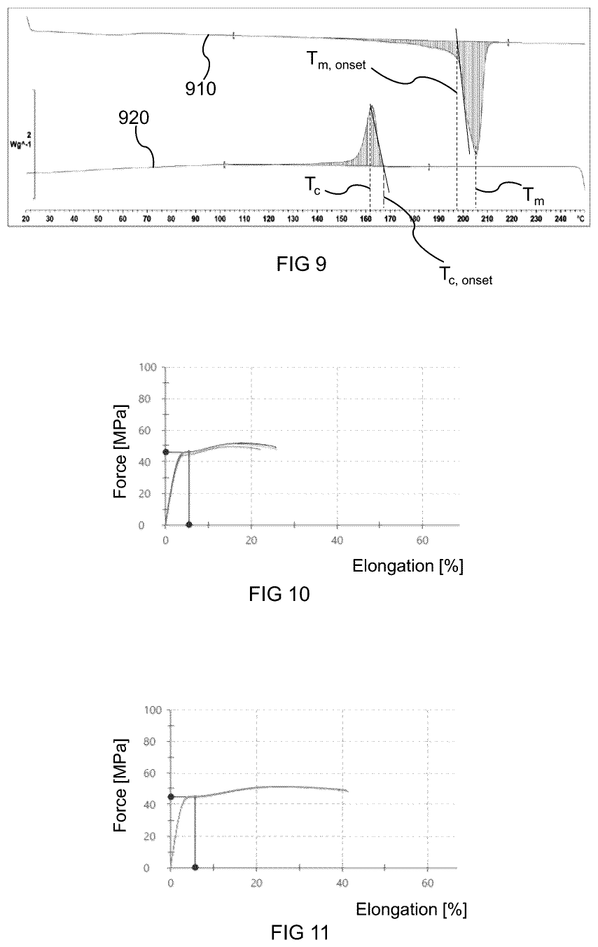

The initial temperature extrapolated from the melting peak T_{m,onset} and the final temperature extrapolated from the crystallization peak T_{c,onset} will be better understood by reading the article Polymers Applicable for Laser Sintering (LS), published by Schmid M. & Wegener K in 2016 (Additive Manufacturing: Procedia Engineering, 149, 457-464), particularly with regard to FIG. 9.

Preferably, ΔT=(Tₘ−T_{c})ₒₙₛₑₜ is comprised between 30° C. and 50° C. This ΔT is advantageous because it makes it possible to define the working temperature T₂. Even more preferably, ΔT=(Tₘ−T_{c})ₒₙₛₑₜ is comprised between 30° C. and 35° C.

In the case of a ΔT lower than 30° C., the polymer risks overreacting to the change of state when energy is added.

For a ΔT greater than 50° C., the risk is not to be able to define a stable working temperature T₂, and consequently to obtain general agglomeration of the powder bed and recovery problems.

Likewise, it is necessary to adapt the energy supply according to the working temperature T₂ choosen in this range ΔT=(Tₘ−T_{c})ₒₙₛₑₜ. Excessive energy input would have the harmful consequence of deforming the 3D printed object.

### Detection Additive

According to an essential feature of the invention, the powder composition comprises a detection additive. This additive is advantageously an inorganic compound which is insoluble in water and non-toxic, preferably of the spinel type. The powder composition of the invention comprises, based on the total weight of the composition, between 1% and 40% by weight of a detection additive.

The detection additive may be an optical detection additive. More particularly, the powder composition of the invention may comprise, with respect to the total weight of the composition, between 0.05% and 5% by weight of an optical detection additive, for example between 0.05% and 0.5%. The latter is advantageously selected from pigments comprising a spinel structure which contains a cation of a transition metal. This type of pigment has the advantage of not being toxic. In particular, the transition metal cation remains trapped in the spinel structure and cannot be solubilized under normal conditions of contact with food and drinks, nor in the event of accidental ingestion through intestinal transit. Spinels have good thermal stability under the laser beam implemented in the SLS laser sintering process technique. The use of these pigments is therefore particularly preferable for powder compositions intended for this use.

According to a particular embodiment, the pigment is a blue pigment, preferably cobalt aluminate (CAS No.: 1345-16-0), which is available under the trade name PB 28.

Preferably, the optical detection additive used allows optical detection, where appropriate by infrared. For example, the optical detection additive used allows optical detection in a wavelength range comprised between 0.5 μm to 12 μm.

According to other embodiments, the pigment comprises an olivine structure or a rutile structure.

It is noted that the optical detection additive is present in a substantially homogeneous manner in the powder composition, so that the parts obtained by additive manufacturing from this powder are colored throughout.

The detection additive may be a magnetic detection additive. More particularly, the powder composition of the invention may comprise, with respect to the total weight of the composition, between 1% and 40% by weight of a magnetic detection additive.

The magnetic detection additive is preferably chosen from oxides comprising a transition metal. For example, the magnetic detection additive is an iron oxide, such as natural or synthetic magnetite (Fe₃O₄). This spinel-type oxide is insoluble in water and is not toxic. Moreover, it is not prone to form metal salts likely to be released by parts obtained by additive manufacturing from this powder. Natural magnetite will be preferred to synthetic magnetite.

Whether as an optical detection additive or as a magnetic detection additive, it is also possible to use an oxide of a transition metal which is not a spinel, or a sulphide of a transition metal. Magnetic detection additives must obviously be selected to present particular magnetic properties, likely to be easily detected.

In a preferred embodiment, the powder composition of the invention comprises both between 0.05% and 5% by weight of an optical detection additive chosen from pigments and between 1% and 40% by weight of a magnetic detection additive chosen from transition metal oxides.

### Choice of Flow Agent

The composition according to the invention further comprises a flow agent in sufficient quantity so that the composition flows freely, remains fluid and forms a uniform, homogeneous and flat layer during the layer building process in powder bed (PBF-Powder Bed Fusion), also called layer-by-layer sintering (SLS, LS) of polymers.

The composition according to the invention comprises, based on the total weight of the composition, between 0% and 5% by weight of a flow agent. A content between 0.1% and 4.5% by weight is preferred.

The flow agent is chosen from those commonly used in the field of sintering polymer powders, for example from: silicas, precipitated silicas, silica fumes, hydrated silicas, vitreous silicas, fumed silicas, vitreous phosphates, vitreous oxides.

Preferably the flow agent has a small contact surface.

### Manufacturing a Powder Composition

According to a specific embodiment, the powder composition according to the invention is obtained according to a manufacturing method which comprises a first step of mixing a so-called “natural” polyamide powder with a flow agent, and at least one step among the following:
a step of mixing the composition obtained previously with a polyamide powder composition comprising an optical detection additive;
a step of mixing the composition obtained previously with a composition comprising a magnetic detection additive.

In specific embodiments, these last two mixing steps with a composition comprising a detection additive are implemented successively; note that their order can be reversed.

A natural polyamide powder is a powder composition comprising between 95% and 100% polyamide, preferably at least 99% by weight of polyamide.

The polyamide powder composition comprising an optical detection additive can be obtained by reduction into powder of a homogeneous liquid or solid mass comprising the polyamide and said optical additive or by solid phase polycondensation, drying, followed by selective grinding.

The composition comprising a magnetic detection additive can either be the magnetic additive in pure form (that is to say comprising at least 95% magnetic detection additive), or can be a composition comprising a polyamide homogenized by dry mixing with a magnetic detection additive.

The mixing steps mentioned above can be carried out by dry mixing (known under the English term “dry blend”) or by a compounding process (known under the English term “master batch”). Compounding requires a subsequent step of selective grinding of the mass obtained and adjustment of the viscosity by solid phase polycondensation and drying; for this reason, the dry mixture is preferred.

The dispersion of the flow agent requires the application of significant mixing energy to obtain good homogenization. This mixing energy can damage the detection additives.

Therefore, it is preferred to opt for a dry premix of the flow agent with a natural polyamide powder during the first mixing step, prior to at least one mixing step with a composition comprising a detection additive, of lower intensity than the first mixing step.

In specific embodiments, the mixing steps are carried out by cryogrinding; this method, well known to those skilled in the art, is not described in detail here.

In these other embodiments, the methods for obtaining a dry mixture of homogeneous and dispersed powder of all the components are adapted according to the initial distributions and the final target distribution, namely:
a particle size distribution D₅₀ comprised between 35 μm and 55 μm,
a particle size distribution D₁₀ comprised between 15 μm and 25 μm and
a particle size distribution D₉₀ comprised between 80 μm and 100 μm.

According to a particular embodiment, the final target particle size distribution of the powder presents:
a particle size distribution D₅₀ comprised between 35 μm and 55 μm, and
a particle size distribution D₁₀ greater than 20 μm and
a particle size distribution D₉₀ less than 80 μm.

### Particle Size Distribution of the Powder Composition

The particle size distribution D₁₀ of the powder composition is greater than 10 μm, preferably greater than 15 μm, preferably greater than 17 μm, preferably greater than 20 μm.

Such a particle size distribution D₁₀ of the powder composition is advantageous to avoid the presence of too large a quantity of fine particles or dust likely to volatilize in the air and present a health risk in the event of inhalation and accumulation, irritation to the eyes and skin contact with these fine dust particles.

The particle size distribution D₅₀ of the powder composition is comprised between 35 μm and 55 μm. Preferably the particle size distribution D₅₀ of the powder composition is comprised between 38 μm and 45 μm, very preferably it is comprised between 38 μm and 40 μm.

The applicant has noted during its tests that these particle size distribution ranges D₅₀ make it possible to obtain the best performance in terms of final resolution, geometric definition of the parts obtained as well as better coverage and good fluidity of the powder at temperature for the PBF powder bed process using layers from 80 μm to 120 μm.

The particle size distribution D₉₀ of the powder composition is less than 110 μm, preferably less than 100 μm, preferably less than 95 μm, preferably less than 93 μm, preferably less than 90 μm. In specific embodiments, the particle size distribution D₅₀ is less than 80 μm.

Such a particle size distribution D₉₀ is advantageous for using the powder in an additive manufacturing process whose layer thickness is between 80 μm and 160 μm, for example for a layer thickness of 100 μm. Preferably, the D₉₀ value is chosen to be less than the layer size envisaged for the additive manufacturing process.

According to a particular embodiment, the powder composition has:
a particle size distribution D₅₀ comprised between 35 μm and 55 μm,
a particle size distribution D₁₀ comprised between 15 μm and 25 μm and
a particle size distribution D₉₀ comprised between 80 μm and 100 μm.

The applicant has noted that such particle size distributions D₁₀, D₅₀, and D₉₀ are advantageous because, although it is advantageous to have a tight distribution and the same morphology for additive manufacturing by sintering, too great a homogeneity of particle size of the powder composition gives rise to “caking” phenomena (i.e., powder agglomeration) because geometric arrangements make the powder more agglomerate. Thus, these particle size distributions D₁₀, D₅₀, and D₉₀ are advantageous because they limit powder agglomeration phenomena and allow easier depowdering of parts obtained by additive manufacturing by sintering.

The particle size distribution values of the powder composition D₁₀, D₅₀ and D₉₀ mentioned above are determined by the static image analysis method according to the ISO 13322-1:2014 standard.

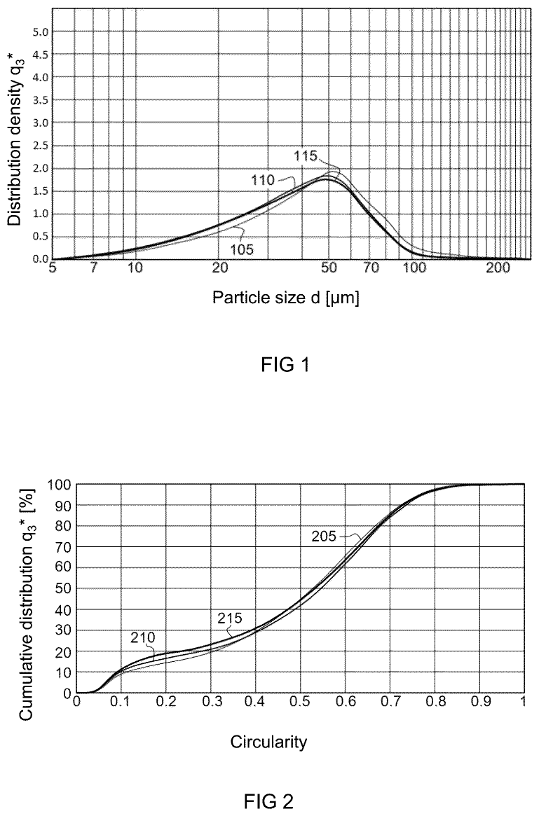

FIG. 1 shows the distribution density curves as a function of particle size (expressed in micrometers, abbreviated μm) for three powders:
curve 105 illustrates the particle size distribution of a so-called natural PA11 powder, that is to say containing at least 99% PA11,
curve 110 illustrates the particle size distribution of a composition A of powder according to the invention, in which the polyamide is a PA11 and which comprises an optical detection additive,
curve 115 illustrates the particle size distribution of a powder composition B according to the invention, in which the polyamide is a polyamide 11 and which comprises both an optical detection additive and a magnetic detection additive.

It should be emphasized that the optical detection additive and/or the magnetic detection additive are selected such as to achieve a particle size distribution of the powder composition as detailed above. As can be seen in FIG. 1, the particle size distribution of the powder compositions according to the invention, with detection additive, remains close to that of the particle size distribution of the distribution of natural PA11 powder, with a density peak around 50 μm.

Advantageously, the powder composition which is the subject-matter of the invention comprises 90%, more preferably 99%, of grains whose size is between 10 μm and 120 μm, preferably between 20 μm and 90 μm, more preferably between 20 μm and 80 μm.

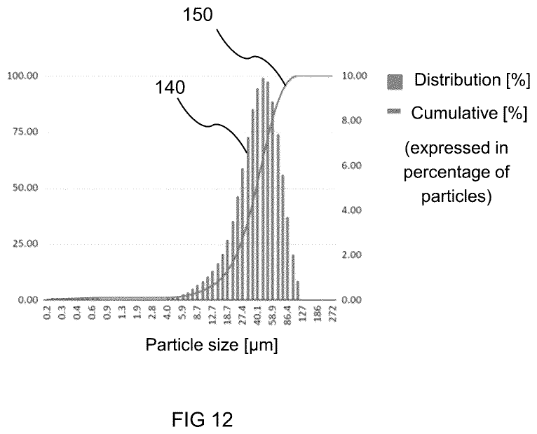

FIG. 12 is a graph which shows the particle size distribution as a function of the particle size of powder composition A, in which the polyamide is a PA11 and which comprises an optical detection additive. The data illustrated in FIG. 12 were obtained from particle size measurements carried out using a Mastersizer 3000 (registered trademark) particle size analyzer from the company Malvern Panalytical. The graph presents bars 140 of a histogram illustrating the percentage of particles in the powder composition associated with each size, expressed in μm. Curve 150 represents the cumulative percentage of particles whose size is less than a threshold value, expressed in μm. As can be seen from the graph on FIG. 12, the powder composition A comprises 90% of grains whose size is between 10 μm and 120 μm.

### Form Factors of the Powder Composition

Form factors are dimensionless quantities used in image analysis and microscopy as a numerical description of the shape of a particle, independent of its size.

The circularity index f_{circ} is a form factor which is calculated as follows:

$${f}_{c i r c} = \frac{4 π A}{{P}^{2}} \qquad [ Math 1 ]$$

where P is the perimeter and A is the surface area of an image of a powder grain.

Thus a sphere which will have a circularity index of 1, while a mica of parallelepiped shape will have a circularity close to 0.

The rules and nomenclature for the description and quantitative representation of particle shape and morphology specified by ISO 9276-6:2008 are followed here.

Preferably, the cumulative distribution f₁₀ of the powder composition according to the invention is less than or equal to 0.15. Very preferably, the cumulative distribution f₁₀ of the powder composition is less than or equal to 0.10. In other words, only 10% of the powder grains have a circularity index less than or equal to 0.15, preferably less than or equal to 0.10. In other words, 90% of the grains have a circularity index greater than 0.1, preferably greater than 0.15.

The cumulative distribution f₅₀ of the powder composition is less than or equal to 0.6. Preferably, the cumulative distribution f₅₀ of the powder composition is less than or equal to 0.55. In other words, only 50% of the powder grains have a circularity index less than or equal to 0.6, preferably less than or equal to 0.55. In other words, 50% of the powder grains have a circularity index greater than 0.55, preferably greater than 0.6.

The cumulative distribution f₉₀ of the powder composition is less than or equal to 0.8. Preferably, the cumulative distribution foo of the powder composition is less than or equal to 0.75. In other words, 90% of the powder grains have a circularity index less than or equal to 0.8, preferably less than or equal to 0.75. In other words, 10% of the powder grains have a circularity index greater than 0.75, preferably greater than 0.8.

FIG. 2 shows a graphical representation of the cumulative distribution on the ordinate (expressed as a percentage), as a function of the circularity on the abscissa (unitless index).

It can be seen from FIG. 2:
curve 205 illustrates the cumulative distribution of a so-called natural PA11 powder, that is to say comprising at least 99% by mass of PA11,
curve 210 illustrates the cumulative distribution of a powder composition according to the invention, in which the polyamide is a PA11 and which comprises an optical detection additive,
curve 215 illustrates the cumulative distribution of a powder composition according to the invention, in which the polyamide is a polyamide 11 and which comprises both an optical detection additive and a magnetic detection additive.

The optical detection additive and/or the magnetic detection additive are preferably selected with a view to obtaining a cumulative distribution of the powder composition as detailed above. It can be seen from FIG. 2 that the cumulative distribution of the powder compositions according to the invention, with detection additive, remains close to that of the particle size distribution of the distribution of natural PA11 powder.

The morphology of the grains is important for the fluidity of the mixture and for the densification of the powder bed during successive coverings but also for the residual porosity in the final parts obtained. Good sphericity of the powder combined with a very tight distribution, that is to say a cumulative distribution of the type presented above, makes it possible to obtain a natural densification of the powder bed by compaction and by geometric arrangements of layer. This layer is then exposed to laser energy for fusion and coalescence favoring the densification of the parts with low residual porosity. Conversely, a very heterogeneous powder with a wider distribution will tend to organize itself in a more chaotic manner and will cause less densification of the powder bed, as some of the larger grains may not be melted.

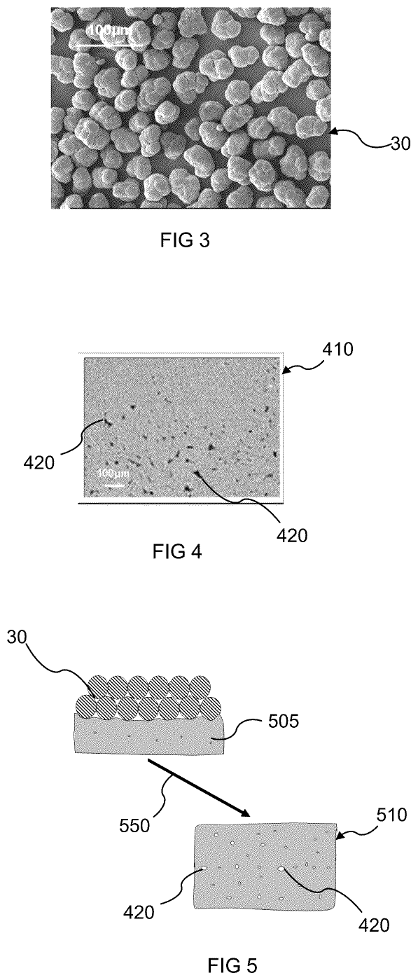

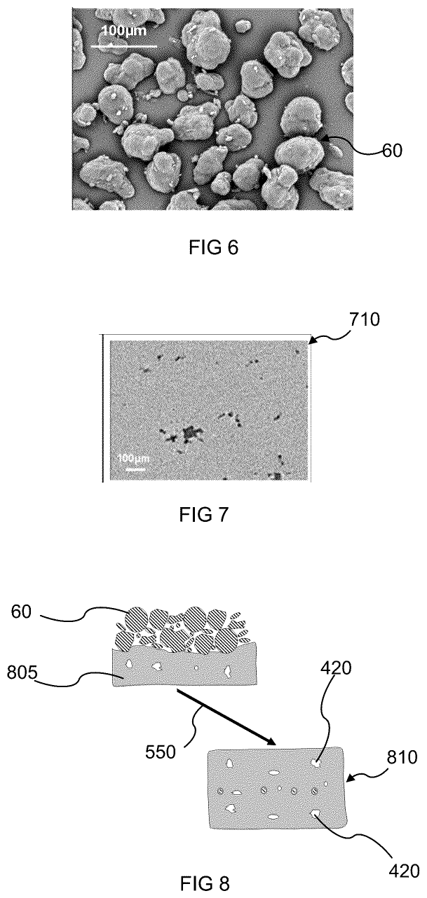

To illustrate this point, FIGS. 3 and 6 present two views captured with a scanning electron microscope of two powders, at the same magnification. FIG. 3 shows a powder which has a sphericity comparable to the sphericity of a powder composition which is the subject of the invention, while the powder in FIG. 6 is presented for comparison.

These powders are subjected to an SLS laser sintering process at an energy density of 34 mJ/mm² (550 and 850). X-ray tomography views of the sections of 3D objects obtained following the sintering process are presented in FIGS. 4 and 7. A schematic representation of powders 30 and 60 illustrated in FIGS. 3 and 6 and sections of 3D objects obtained by sintering of these powders are presented in FIGS. 5 and 8.

The powder 30 illustrated in FIG. 3 is a powder with good circularity homogeneity with a grain circularity of between 0.4 and 0.8, on average equal to 0.65. Powder 30, placed on a previously solidified layer 505 and subjected to an SLS laser sintering process 550 at an energy density of 34 mJ/mm², makes it possible to obtain a low and distributed residual porosity, as illustrated in section 410 in FIG. 4, obtained by tomography of the 3D object, and on section 510 in FIG. 5. The porous portions 420 which appear in black in FIG. 4 are illustrated in the form of white cavities in FIG. 5. These porous portions are fewer in number and better distributed than those observed on the sections of a 3D object obtained by sintering from a powder with less homogeneity of circularity of the grains, represented in FIGS. 7 and 8.

Powder 60 illustrated in FIG. 6 has less homogeneity than powder 30, with a grain circularity of between 0.1 and 0.8, on average equal to 0.55. Powder 60, placed on a previously solidified layer 805 and subjected to an SLS laser sintering process 550 at an energy density of 34 mJ/mm², resulted in a 3D object with less homogeneity and greater residual porosity, which is shown in section 710 on FIG. 7 obtained by tomography, and as a schematic section 810 in FIG. 8.

### Manufacturing Process of 3D Objects

It is recalled that the present patent application falls within the framework of technologies involving a powder bed with agglomeration layer by layer, such as to obtain a three-dimensional object. In the context of this document, we designate these methods only by the terms “additive manufacturing” or “3D printing”. We will refer to a “3D object” as an object obtained by such a 3D printing method.

The present invention relates more particularly to an additive manufacturing process by powder bed fusion (PBF), layer by layer, from a polyamide powder in a heated enclosure. These methods include in particular laser sintering (LS), selective laser sintering (SLS), Multi Jet Fusion (MJF), infrared radiation sintering (IRS) and high-speed sintering (HSS).

Whatever the additive manufacturing method chosen, the process according to the invention aims to manufacture 3D polyamide objects comprising a detection additive, from a polyamide powder composition.

The process according to the invention takes place in a closed enclosure preheated to a set temperature T₁. The atmosphere inside the enclosure is enriched in nitrogen (or under vacuum) and depleted in oxygen, in order to limit the oxidation of the polymer powder; this oxidation gradually leads to the elongation of the macromolecules constituting the polymer powder particles and represents the main aging mechanism of said powders. This elongation of the macromolecules tends to increase the internal viscosity of the polymer. Limiting the temperature oxidation of the powders promotes the recycling of unused powder, which contributes significantly to the economy of the process according to the invention. Preferably, the oxygen level is less than 5% by volume, preferably less than 2%, and even more preferably less than 1%.

The holding temperature T₁ is advantageously located at approximately 20 to 30 degrees around the crystallization temperature T_{c} of the polymer. According to an advantageous embodiment, for a powder based on polyamide PA11 and/or PA12, the preheating temperature T₁ is advantageously between approximately 140° C. and approximately 160° C., preferably between approximately 142° C. and approximately 158° C. According to specific embodiments, the heating temperature is equal to the holding temperature.

More generally, the holding temperature T₁ is preferably between 150 and 185° C.

The process which is the subject-matter of the invention comprises the deposition of a uniform layer of a bed of polyamide powder in a preheated enclosure. Immediately after the deposition of each layer, the surface of the powder bed is heated rapidly, typically by infrared radiation, to a temperature T₂ which is selected to be approximately 8% to 14% lower than the Tₘ of the polyamide (i.e. 12 to 26 degrees lower than the melting temperature Tₘ of the powder). This heating to a temperature T₂ makes it possible to maintain the polyamide powder at a temperature fairly close to its melting temperature, without however reaching this melting temperature. This temperature is also called the working temperature for PBF systems.

According to an advantageous embodiment, for a powder based on polyamide PA11 and/or PA6, the temperature T₂ is between approximately 183° C. and approximately 204° C.

More generally, the temperature T₂ is between 168° C. and 206° C.

Melting of the powder is necessary to obtain a compact part. This melting must be transient, rapid, localized and controlled, so as to avoid the uncontrolled flow of the liquid polymer; for this reason it must be brief, that is to say that the localized melting must be promptly followed by cooling to a temperature below the melting point Tₘ of the polymer, towards a temperature T_{R} at which the polymer can recrystallize from the molten state. Said temperature T_{R} can be in the vicinity of the temperature T₂; it is comprised between T₁ and T₂.

To obtain said localized and controlled fusion of a selected portion of the powder bed, electromagnetic radiation irradiates targeted areas of the polyamide powder, making it possible to locally increase the temperature and to agglomerate the polyamide grains of the targeted areas. Depending on the method chosen, the electromagnetic radiation is for example visible, infrared or near-infrared laser radiation. The local temperature TL of the melting zone is preferably approximately 8% to 14% higher than the Tₘ of the polyamide (i.e., 12 to 26 degrees higher than the melting temperature Tₘ of the powder). A transient liquid phase is thus formed, but if TL is too high, the viscosity of the molten polymer becomes too low and there is a risk of sagging.

By way of particular example, the temperatures T₁ and T₂ implemented during a sintering process according to the invention are gathered in table 1 below and compared with the melting point Tₘ and the crystallization temperature T_{c} of the sintering powders A and B according to the invention.

TABLE 1

| | Tₘ | T_{c} | T_{m, onset} | T_{c, onset} | ΔT | T₁ | T₂ |
|---|---|---|---|---|---|---|---|
| | [° C.] | [° C.] | [° C.] | [° C.] | [° C.] | [° C.] | [° C.] |
| Powder A: optical | 202 | 163 | 198 | 168 | 30 | 155 | 186 |
| additive | | | | | | | |
| Powder B: optical | 202 | 164 | 199 | 168 | 31 | 155 | 184 |
| and magnetic | | | | | | | |
| additives | | | | | | | |

It is specified that:
powder A is a powder composition according to the invention, in which the polyamide is a PA11 and which comprises an optical detection additive, and
powder B is a powder composition according to the invention, in which the polyamide is a polyamide 11 and which comprises both an optical detection additive and a magnetic detection additive.

For the determination of any interval centered on the melting temperature or the crystallization temperature, it is preferably made use of an initial temperature extrapolated from the melting peak (T_{m,onset}) and the final temperature extrapolated from the crystallization peak (T_{c,onset}), rather than of the temperature values corresponding to the melting and crystallization peaks, although the two methods for determining these reference values can be implemented without deviating from the invention.

To illustrate this point, it is referred in FIG. 9 to a DSC (Differential Scanning calorimetry) of a powder composition according to the invention based on PA11. This DSC shows an initial temperature rise curve 910 and a cooling curve 920.

The melting and crystallization temperatures are illustrated on this graph, whether determined by identification of the corresponding peak (T_{c} and Tₘ) or at the initial temperature extrapolated for the melting peak (T_{m,onset}) and at the final temperature extrapolated for the crystallization peak (T_{c,onset}).

Once all of the targeted areas of a powder bed layer have been scanned by the electromagnetic radiation source, a new powder bed is deposited and flattened on top of the previous one.

It should be remembered that the powder is self-supporting, that is to say it rests on the powder previously deposited during the process. So each time, a new powder bed is deposited and the solidification of a portion of the new powder bed is initiated. The solidified portion of each powder bed corresponds to a layer or slice of the 3D object obtained at the end of the process.

The thickness of each layer is typically between approximately 50 μm and approximately 150 μm, preferably between approximately 70 μm and approximately 120 μm, and even more preferably between approximately 80 μm and approximately 110 μm. The deposition of each layer is followed by heating to temperature T₂, as described above.

According to one embodiment of the method, the sintering which is the subject of the invention is carried out by SLS and the electromagnetic radiation causing the localized fusion of a layer is laser radiation with an energy density greater than or equal to 25 mJ/mm² for a working temperature T₂ between 180° C. and 199° C., for example equal to 188° C. The energy density greater than or equal to 25 mJ/mm² makes it possible to avoid layer delamination, that is to say the separation between two successive layers of solidified polyamide.

The energy density is calculated using the simplified Morgan formula, which is expressed as follows:

$${E}_{p} = \frac{P \cdot 2 \cdot r \cdot 2 \cdot r}{π \cdot {r}^{2} \cdot v \cdot S} = \frac{4 \cdot P}{π \cdot v \cdot S} \qquad [ Math 2 ]$$

where P is the power of the laser, expressed in Watts,
S is the spacing between scans (hatch deviation), expressed in millimeters (mm),
v is the laser speed, expressed in mm/second, and
r is the laser radius, expressed in mm.

As examples, the operating conditions of sintering processes according to the invention with different SLS systems are summarized in Table 2 below. These operating conditions are implemented on a sintering powder composition comprising PA 11, with a fixed layer thickness of 100 μm, at a working temperature T₂ approximately equal to 188° C.

TABLE 2

| Energy | Laser | Laser speed | Hatch deviation or |
|---|---|---|---|
| density | power | (scan speed) | spacing between |
| [mJ/mm²] | [W] | [mm/s] | scans[mm] |
| 27 | 70 | 12700 | 0.26 |
| 35 | 22 | 3200 | 0.25 |
| 29.3 | 14.5 | 3500 | 0.18 |
| >35 | 7 | 900 | 0.25 |

The 3D object resulting from the sintering process is still covered with non-agglomerated powder. This powder is removed by mechanical and/or chemical means well known to those skilled in the art (air jet or water jet, brushing, sanding, solvent phase treatment, ultrasonic bath, treatment with an HF solution, etc.) which are not detailed here.

Reuse of the Polyamide Powder Composition which is the Subject of the Invention

During a process such as that described above, part of the powder composition for an additive manufacturing process using a PBF (Power Bed Fusion) powder bed according to the invention introduced into the heating chamber is not solidified. Advantageously, this powder is collected and sieved with a view to its reuse in mixture with a composition of fresh polyamide powder, that is to say with a powder which has not already been used in a sintering process.

Preferably, the powder composition according to the invention comprises a mass fraction of between 20% and 70% of fresh polyamide powder composition, and a mass fraction of between 80% and 30% of polyamide powder recovered after a previous manufacture. More preferably, the deposited powder bed comprises a mass fraction of between 25% and 55% of fresh polyamide powder composition, and a mass fraction of between 75% and 45% of polyamide powder recovered at the end of a previous manufacture.

Adding fresh powder to spent powder adds undamaged (non-thermo-oxidized) polyamide grains, which are not already damaged or deformed by a previous sintering process inducing thermo-oxidation, and thus maintains the internal viscosity of the mixture in a given range by lowering this viscosity with each cycle as it evolves.

Preferably, the fresh polyamide powder used has an internal viscosity number measured according to ISO 307:2019 of between 0.9 deciliters per gram and 1.4 deciliters per gram.

An internal viscosity number of less than 1.4 deciliters per gram, preferably less than 1.2 deciliters per gram, makes it possible to keep the internal viscosity of the polyamide powder composition sufficiently low, even when this composition is obtained by mixing a fresh powder with recycled powder used in a PBF powder bed process.

The method for determining the internal viscosity number of plastics and polyamides, according to standard ISO 307:2019, is based on the determination of the viscosity number of diluted solutions of polyamides in certain solvents specified in the aforementioned standard.

This viscosity is involved in the rheology of melting and/or coalescence phenomena: the deposited particles must melt and coalesce to form a dense, non-porous mass, but without creeping in an uncontrolled manner. Internal viscosity influences the mechanical properties of the part, its appearance and surface finish of the finished product.

For optimal use of the powder composition it is advisable not to exceed a number of recycling cycles for the same powder, that is to say not to recycle again a mixture of powder which has undergone a high number of thermal cycles in a PBF powder bed process. Collection of the cycled powder and its sieving must precede mixing with fresh polyamide powder in order to remove aggregates of powder grains.

The number of possible cycles depends on the degree of oxidation of the recycled powder, knowing that the internal viscosity increases with the degree of oxidation.

The inventors note that on average the same powder can be reused in 8 to 10 recycling cycles, but this depends mainly on the duration of exposure of the powder to a high temperature and on the oxygen level in the enclosure, throughout the thermal cycle undergone (preheating, manufacturing at temperature and cooling) either during the entire manufacturing process in PBF or during cooling to a temperature below 60° C.

Recycling is favored by the fact that the fresh powder has the internal viscosity indicated above. Indeed, to manufacture good quality parts by the process according to the invention, it is possible to use a powder whose internal viscosity number is located a little outside this zone between 0.9 deciliters per gram and 1.4 deciliters per gram, but so that the fresh powder can be recycled in the PBF process, under attractive economic conditions and according to the technical conditions indicated above (mixed with fresh powder at a rate of 30% to 60%), it is preferable to respect, for fresh powder, continuous refreshing at 50% and systematic sieving of the already cycled powder.

As an example, the composition according to the invention is powder A (already described above). Fresh powder A has an internal viscosity number equal to 1.3 deciliters per gram.

After implementing a sintering process, a new powder composition according to the invention is formed by mixing half fresh powder and half recycled powder. After one or two cycles, the powder composition has an internal viscosity number of the order of 1.7 deciliters per gram.

After three to six cycles, the powder composition has an internal viscosity number of around 2.05 deciliters per gram.

TABLE 3

| | Evolution of the internal viscosity number | | |
|---|---|---|---|
| | (in deciliters per gramm at 25° C.) | | |
| Powder | Fresh powder | Refreshed powder | Refreshed powder |
| | Temperature time | (1 to 2 cycles) | (3 to 6 cycles) |
| | t° = 0 hours | Temperature time | Temperature time |
| | | t° > 20 hours | t° > 50 hours |
| Powder A: | 1.3 | 1.7 | 2.05 |
| Optical | | | |
| additive | | | |

Instead of the number of cycles, the temperature time can be taken into consideration, that is to say the time during which the powder composition is subjected to heating in the heated enclosure. This approach can be more precise because the manufacturing cycles can be longer or shorter. In the table above, the temperature time values used to arrive at the values of the internal viscosity numbers are also indicated. This temperature time is equal to 0 for a fresh powder, it is greater than 20 hours for a powder having undergone 1 to 2 cycles, and greater than 50 hours for a powder having undergone 3 to 6 recycling cycles.

### Magnetic Detection of the 3D Objects Obtained

The presence of an optical or magnetic detection additive in the powder composition of the invention allows the detection of 3D objects obtained by sintering of this powder.

In the case of magnetic detection, the 3D objects obtained from a powder comprising a magnetic detection additive are for example detected by electromagnetic induction or according to any other method of detecting a magnetic object. These methods, well known to those skilled in the art, are not described here.

### Optical Detection of the 3D Objects Obtained

The 3D objects obtained by additive manufacturing of a powder composition are colored in the mass, that is to say that the material constituting the 3D object is colored and that the object does not only present a coloring on its exterior surface.

This characteristic allows a broken 3D object fragment to present on all its faces the color corresponding to the optical detection additive used. Thus, a fragment of an object colored in the mass can be detected by optical detection methods, when the object is broken.

Preferably, the 3D object is colored blue throughout. Since the color blue is uncommon among food products, it stands out more easily than other colors when found among food products. In particular, infrared detection can be implemented by irradiation in a wavelength range between 0.5 μm and 12 μm. These optical detection methods, even applied to fragments of plastic materials, are well known to those skilled in the art and will not be described here in greater detail.

### Mechanical Properties of 3D Objects Obtained by Sintering According to the Invention

Preferably, a 3D object obtained by sintering according to the invention has a lowest tensile strength greater than or equal to 40 MPa (megapascals), preferably greater than or equal to 44 MPa.

In the case where the 3D object is obtained by sintering of a powder comprising a magnetic detection additive, the 4D object preferably has a lowest tensile strength greater than or equal to 30 MPa, very preferably greater than or equal to 35 MPa.

Preferably, a 3D object obtained by sintering according to the invention has a lowest elastic modulus greater than or equal to 1600 MPa, preferably greater than or equal to 1750 MPa.

In particular, standardized test pieces of 3D objects obtained from a sintering process according to the invention were tested for their tensile strength and their modulus of elasticity, expressed in megapascals (MPa), and for their elongation at the break, expressed as a percentage. The 3D object tested is obtained from a sintering powder composition A according to the invention comprising an optical detection additive in which the polyamide is PA11. The test method implemented complies with the ISO 527-1:2019 standard for the determination of tensile properties.

TABLE 4

| | Tensile | Elongation | Elastic |
|---|---|---|---|
| | strength | at break | modulus |
| | [MPa] | [%] | [MPa] |
| Powder A: | 45.5 | 25 | 1794 |
| Optical additive | | | |
| (orientation xy) | | | |
| Powder A: | 44.9 | 40 | 1827 |
| Optical additive | | | |
| (orientation xz) | | | |

Preferably, the 3D objects obtained by the method according to the invention have an elongation at break greater than or equal to 20% on a first orientation and greater than or equal to 35% on a second orientation, perpendicular to the first.

In tests carried out according to ISO 527-1:2019, the results of which are presented in Table 4 above, these elongations at break were measured as 25% and 40%.

FIGS. 10 and 11 show the graphs corresponding to the test results presented above for elongation at break: in FIG. 10 the results of the tensile elongation test in an xy orientation and in FIG. 11 the results of the tensile elongation test in an xz orientation.

1-13. (canceled)

14. A method for manufacturing a three-dimensional object, the method comprising:
causing a local increase in temperature of a polyamide-based powder by electromagnetic radiation in a heated enclosure;
causing a localized fusion of a layer of a predetermined thickness to form, after cooling, a solid layer of polyamide,
wherein the polyamide-based powder comprises, with respect to a total weight of a composition thereof:
between 60% and 99% by weight of polyamide,
between 1% and 40% by weight of an optical and/or magnetic detection additive selected from the group consisting of: pigments comprising a spinel structure which contains a cation of a transition metal, oxides of a transition metal, and sulphides of a transition metal, and
between 0.1% and 4.5% by weight of a flow agent,
wherein the polyamide-based powder has:
a particle size distribution D₅₀ between 35 μm and 55 μm,
a particle size distribution D₁₀ that is greater than 15 μm, and
a particle size distribution D₉₀ that is less than 100 μm.

15. The method of claim 14, wherein:
a mass fraction of between 30% and 70% of the polyamide-based powder is fresh polyamide powder,
a mass fraction of between 70% and 30% of the polyamide-based powder is polyamide powder recovered in the heated enclosure at a conclusion of a previous manufacturing process,
the fresh polyamide powder has an internal viscosity number measured at 25° C. (in accordance with ISO 307:2019) between 0.9 deciliters per gram and 1.4 deciliters per gram.

16. The method of claim 14, wherein the electromagnetic radiation is laser radiation with an energy density greater than 25 mJ/mm².

17. A powder composition for an additive manufacturing process by locally raising a temperature of a polyamide-based powder by electromagnetic radiation in a heated enclosure, causing a localized fusion of a layer of a predetermined thickness to form, after cooling, a solid layer of polyamide,
wherein the polyamide-based powder comprises, on total weight of the powder composition:
between 60% and 99% by weight of polyamide,
between 1% and 40% by weight of an optical detection additive and/or a magnetic detection additive, selected from the group consisting of: pigments comprising a spinel structure which contains a cation of a transition metal, oxides of a transition metal, and sulphides of a transition metal;
between 0.1% and 4.5% by weight of a flow agent, and
wherein the polyamide-based powder has:
a particle size distribution D₅₀ between 35 μm and 55 μm,
a particle size distribution D₁₀ that is greater than 15 μm, and
a particle size distribution D₉₀ that is less than 100 μm.

18. The powder composition of claim 17, wherein the polyamide-based powder has:
a particle size distribution D₅₀ between 35 μm and 55 μm,
a particle size distribution D₁₀ between 15 μm and 25 μm and
a particle size distribution D₉₀ between 80 μm and 100 μm.

19. The powder composition of claim 17, wherein the powder composition is formed by dry mixing of a natural polyamide powder with a polyamide powder comprising a detection additive.

20. The powder composition of claim 17, wherein the polyamide-based powder comprises:
between 0.05% and 5% by weight of an optical detection additive chosen from pigments comprising a spinel structure which contains a cation of a transition metal and
between 1% and 35% by weight of a magnetic detection additive among transition metal oxides.

21. The powder composition of claim 17, wherein the polyamide-based powder has an internal viscosity number measured, in accordance with ISO 307:2019, of between 0.9 and 1.4 deciliters per gram, at 25° C.

22. The powder composition of claim 17, wherein the polyamide-based powder has a value ΔT=(Tₘ−T_{c})ₒₙₛₑₜ between 30° C. and 50° C.

23. The powder composition of claim 17, wherein the polyamide-based powder comprises an optical detection additive comprising cobalt blue.

24. A three-dimensional object obtained by additive manufacturing from the powder composition of claim 17.

25. The three-dimensional object of claim 24, wherein the polyamide-based powder has:
a particle size distribution D₅₀ between 35 μm and 55 μm,
a particle size distribution D₁₀ between 15 μm and 25 μm and
a particle size distribution D₉₀ between 80 μm and 100 μm.

26. The three-dimensional object of claim 24, wherein the powder composition is formed by dry mixing of a natural polyamide powder with a polyamide powder comprising a detection additive.

27. The three-dimensional object of claim 24, wherein the polyamide-based powder comprises:
between 0.05% and 5% by weight of an optical detection additive chosen from pigments comprising a spinel structure which contains a cation of a transition metal and
between 1% and 35% by weight of a magnetic detection additive among transition metal oxides.

28. The three-dimensional object of claim 24, wherein the polyamide-based powder has an internal viscosity number measured, in accordance with ISO 307:2019, comprised between 0.9 and 1.4 deciliters per gram, at 25° C.

29. The three-dimensional object of claim 24, wherein the polyamide-based powder has a value ΔT=(Tₘ−T_{c})ₒₙₛₑₜ comprised between 30° C. and 50° C.

30. The three-dimensional object of claim 24, wherein the polyamide-based powder comprises an optical detection additive comprising cobalt blue.

31. The three-dimensional object of claim 30, wherein the optical detection additive allows optical detection in a wavelength range of between 0.5 μm and 12 μm.

32. The three-dimensional object of claim 30, wherein the three-dimensional object has a modulus of elasticity greater than or equal to 1600 MPa, a tensile strength greater than or equal to 30 MPa, an elongation at break greater than or equal to 20% in accordance with a first orientation and greater than or equal to 35% on a second orientation perpendicular to the first orientation.
